(19) United States
(12) Patent Application Publication
(10) Pub. No.: US 2023/0398557 A1
(43) Pub. Date: Dec. 14, 2023

(54) DECANTING THREE PHASE CENTRIFUGE

(71) Applicant: Hi Tech LLC dba Gtech USA, Oak Ridge North, TX (US)

(72) Inventor: Kevin William BELL, Oak Ridge North, TX (US)

(21) Appl. No.: 18/208,131

(22) Filed: Jun. 9, 2023

Related U.S. Application Data
(60) Provisional application No. 63/350,692, filed on Jun. 9, 2022.

(51) Int. Cl. B04B 11/02; B04B 1/20

(52) U.S. Cl. CPC B04B 11/02; B04B 1/20; B04B 2001/2083

(57) ABSTRACT

In a decanting three-phase centrifuge, the position of the paring disc within a paring pump chamber defined by a rotatable bowl is radially adjustable to provide a cut point between a heavy fluid phase and a light fluid phase of a slurry and thereby separate the two phases. At least one sensor senses a fluid parameter of the separated heavy fluid phase and/or the separated light fluid phase and outputs a fluid parameter signal representative of the sensed fluid parameter. The control unit is programmed to, on the fly; receive the fluid parameter signal; determine from the received fluid parameter signal whether the cut point is to be adjusted; and if the cut point is to be adjusted, automatically drive the actuator to radially adjust the paring disc and thereby reset the cut point on the fly while the centrifuge is operating.

### CROSS REFERENCE TO RELATED APPLICATIONS

The present application claims priority to and the benefit of U.S. Prov. Pat. App. Ser. No. 63/350,692, which was filed on Jun. 9, 2022, which to the extent that it is consistent with the present disclosure is hereby incorporated herein by reference in its entirety.

### TECHNICAL FIELD

This disclosure relates to a decanting three-phase centrifuge for separating various phases of a slurry.

### BACKGROUND

This section of this document introduces information about and/or from the art that may provide context for or be related to the subject matter described herein and/or claimed below. It provides background information to facilitate a better understanding of the various aspects of the present invention. This is a discussion of “related” art. That such art is related in no way implies that it is also “prior” art. The related art may or may not be prior art. The discussion in this section of this document is to be read in this light, and not as admissions of prior art.

In hydrocarbon and production operations, different types of separation devices are used for separating a mixture of fluid phases of different densities from a solid phase. The separation of the fluid phases from the solid phase may be desirable in order to, for example, provide a fluid phase of a desired density and/or viscosity. The separation may also be desirable in order to provide a final product having properties that allow either the fluid phase or solid phase to be reusable in the production operation.

While different types of separation devices are used, typical separation devices operate through either the principle of cyclone or centrifuge separation. In cyclone separators, the flow is introduced into a chamber in a tangential manner at high energy, thereby inducing a rotating flow pattern within the chamber that causes lighter components to migrate toward the chamber axis while heavier components migrate toward the outside. In centrifuge separators, a mixture is introduced into a vessel that is rotatable about an axis. The vessel is then rotated at a desired speed, such that denser components of the mixture migrate to the outside while lighter components accumulate nearer the centrifuge axis. In certain centrifuges, the outer wall of the vessel is porous, so that liquid components may be extracted, thereby leaving solid material on the porous wall of the vessel.

During hydrocarbon production operations, fluids that are used in the operation are often recycled to reduce costs. As part of the recycling operation, fluids may be passed through a separator to remove solids allowing for reuse of a fluid phase. In such operations, the removal of the solid phase may also make the solid phase reusable in other aspects of the operation.

### BRIEF SUMMARY

A decanting three-phase centrifuge comprising a rotatable bowl, a paring disc, an actuator, at least one sensor, and a control unit. The rotatable bowl defines a paring pump chamber in which the paring disc is disposed. The position of the paring disc is radially adjustable to provide a cut point between a heavy fluid phase and a light fluid phase of a slurry and thereby separate the light fluid phase from the heavy fluid phase. The actuator is disposed outside the rotatable bowl to radially adjust the position of the paring disc. The at least one sensor senses a fluid parameter of a first one of the separated heavy fluid phase and the separated light fluid phase and output a fluid parameter signal representative of the sensed fluid parameter. The control unit is programmed to, on the fly: receive the fluid parameter signal from the at least one sensor; determine from the received fluid parameter signal whether the cut point is to be adjusted; and if the cut point is to be adjusted, automatically drive the actuator to radially adjust the paring disc and thereby reset the cut point on the fly while the centrifuge is operating.

A fluid optimization system, comprises: a slurry delivery system, a decanting three-phase centrifuge, a separated phases collection system, and a flow control system. The slurry delivery system delivers a slurry including solids phase, a heavy fluid phase, and a light fluid phase to the decanting three-phase centrifuge for separation. The separated phases collection system collects the separated phases from the decanting three-phase centrifuge. The flow control system controls the flow of fluids through the fluid optimization system, including from the slurry delivery system to the decanting three-phase centrifuge and from the decanting three-phase centrifuge to the separated phases collection system.

The decanting three-phase centrifuge of the fluid optimization system comprises a rotatable bowl, a paring disc, an actuator, at least one sensor, and a control unit. The rotatable bowl defines a paring pump chamber in which the paring disc is disposed. The position of the paring disc is radially adjustable to provide a cut point between a heavy fluid phase and a light fluid phase of a slurry and thereby separate the light fluid phase from the heavy fluid phase. The actuator is disposed outside the rotatable bowl to radially adjust the position of the paring disc. The at least one sensor senses a fluid parameter of a first one of the separated heavy fluid phase and the separated light fluid phase and output a fluid parameter signal representative of the sensed fluid parameter. The control unit is programmed to, on the fly: receive the fluid parameter signal from the at least one sensor; determine from the received fluid parameter signal whether the cut point is to be adjusted; and if the cut point is to be adjusted, automatically drive the actuator to radially adjust the paring disc and thereby reset the cut point on the fly while the centrifuge is operating.

A method of separating a solid phase, a heavy fluid phase, and a light fluid phase from a slurry in a decanting three-phase centrifuge comprises: removing the solid phase from a slurry in the decanting three-phase centrifuge; separating the light fluid phase from the heavy fluid phase in the decanting three-phase centrifuge at a cut point; monitoring at least one of the separated heavy fluid phase and the separated light fluid phase, including transmitting a fluid parameter signal representative of a sensed fluid parameter of at least a first one of the separated heavy fluid phase and the separated light fluid phase; receiving the fluid parameter signal from the at least one sensor; determining from the received fluid parameter signal whether the cut point is to be adjusted; and if the cut point is to be adjusted, automatically radially adjusting the position of the paring disc in the decanting three-phase centrifuge and thereby reset the cut point on the fly while the decanting three-phase centrifuge is operating.

The above presents a simplified summary of the invention as claimed below in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

### BRIEF DESCRIPTION OF THE DRAWINGS

The invention may be understood by reference to the following description taken in conjunction with the accompanying drawings, in which like reference numerals identify like elements, and in which:

FIG. 1 is a schematic representation of a decanting three-phase centrifuge, according to one or more examples of the disclosure.

FIG. 2A is a cross-sectional view of a decanting three-phase centrifuge, according to one or more examples of the disclosure.

FIG. 2B illustrates a three-phase separation in the decanting three-phase centrifuge of FIG. 2A.

FIG. 3 is a cross-sectional view of a portion of a bowl of a decanting three-phase centrifuge, such as the decanting three-phase centrifuge of FIG. 2, according to one or more examples of the disclosure.

FIG. 4A is a top, plan view of the paring disc of the bowl of FIG. 3 according to one or more examples of the disclosure.

FIG. 4B-FIG. 4C illustrate in two opposing perspective views the paring disc of FIG. 4A mounted to a sleeve over the feed tube, and both linked to and driven by the actuator of FIG. 5-FIG. 6.

FIG. 4D illustrates the separation of the light fluids phase 258 from the heavy fluids phase 257 for decanting and removal.

FIG. 5 is a side view of an actuator for a decanting three-phase centrifuge, according to one or more examples of the disclosure.

FIG. 6 is a perspective view of an adjustment for an actuator for a decanting three-phase centrifuge, according to one or more examples of the disclosure.

FIG. 7 is a schematic representation of a decanting three-phase centrifuge, according to one or more examples of the disclosure.

FIG. 8A, FIG. 8B, and FIG. 8C are cross-sectional views of a rotary pump, according to one or more examples of the disclosure.

FIG. 9 and FIG. 10 are cross-sectional view of a valve according, according to one or more examples of the disclosure.

FIG. 11 is a schematic representation of a process flow for a fluid optimization system, according to one or more examples of the disclosure.

FIG. 12 is a flowchart depicting a method for separating solids, heavy fluid phases, and light fluid phases, according to one or more examples of the disclosure.

FIG. 13 is a schematic representation of a control unit according to one or more examples of the disclosure.

FIG. 14 is a schematic representation of a second control unit according to one or more examples of the disclosure.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

Embodiments of the present disclosure may provide methods and systems for controlling the density of fluids in hydrocarbon production operations. In certain embodiments, automated control units may be used to control various components in the system, thereby allowing a fluid composition in the system to be optimized prior to use or reuse. For example, control units may be used to control pumps, valves, meters, separators, tanks, agitation systems, and other system components as may be desired to produce an optimized fluid. As used herein, the term “optimized” and its derivatives, such as “optimizing”, refer to achieving a desired operational state as defined by predetermined parameters. In selected embodiments, these parameters may define a state of a fluid that is relatively free of undesirable solids and heavy fluid such as oil.

More particularly, the present disclosure provides a decanting three-phase separator in which the radial position of the paring disc may be adjusted automatically and on the fly to reset the cut point in a light fluid phase and heavy fluid phase separation. The term “automatically” and its derivatives, as used herein, means that the stated action—for instance, the radial position adjustment of the paring disc—occurs under automated control and without human intervention. The term “on the fly” and other similar terms means that the stated action—for example, the radial position adjustment of the paring disc—occurs while the centrifuge is operating and without having to stop such operation.

As those in the art having the benefit of this disclosure will appreciate, following separation of the solid phase, the remaining slurry comprises the heavy fluid phase and the light fluid phase. The remaining slurry is directed into a paring pump chamber defined by a rotating bowl of a bowl assembly. The rotation generates forces operating radially from the axis of rotation for the bowl. These forces separate the heavy fluid phase and the light fluid phase into concentric rings, each also described herein as an “annulus”, against the inner surface of the outer wall of the rotating bowl. The light fluid phase forms an inner ring and the heavy fluid phase forms an outer ring.

The paring disc includes a “tooth” or “pick” on the outer edge thereof. The paring disc is positioned so that the tooth is placed to pick and collect the inner ring of the light fluid phase. The “cut point” is the point at which the tooth is placed to perform this collection. It is desirable that the cut point be at the transition between the light fluid phase forms the inner ring and the heavy fluid phase forms the outer ring in order to more accurately separate the two phases.

Over time, the transition point between the light fluid phase and the heavy fluid phase may change depending on the properties of the remaining slurry. This may result in collecting heavy fluids along with the light fluid phase or failing to collect light fluids that remain with the heavy fluid phase. This inaccurate separation is undesirable. The cut point is therefore reset to the new point of transition between the two phases once it has been realized that transition point has changed.

In conventional practice, all this activity is performed manually and requires that operation of the decanting three-phase separator. This is also undesirable as it forces separation to cease even while the slurry continues to be fed. Accordingly, the present disclosure provides a decanting three-phase separator and a method for using the same to separate the three phases of a slurry in the context of a fluid optimization system that automatically sets or resets the cut point of the decanting three-phase separator on the fly.

Turning now to the drawings, a decanting three-phase separator and a method for using the same to separate the three phases of a slurry in the context of a fluid optimization system that automatically sets or resets the cut point of the decanting three-phase separator on the fly will now be disclosed. Before describing one particular system in detail, individual components of the system are discussed below.

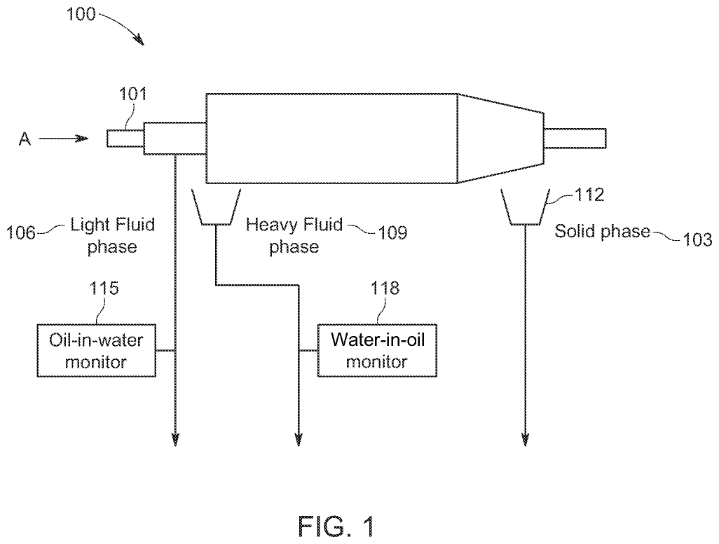

FIG. 1 is a schematic representation of a decanting three-phase centrifuge 100 according to one or more examples of the disclosure. In operation, a slurry containing a mixture of solids, light liquids, and heavy liquids may be introduced into centrifuge 100 through the inlet 101 from the direction A indicated by the arrow. In this representation, the centrifuge 100 may be used to separate a solids phase 103, a light fluid phase 106, and heavy fluid phase 109 from the slurry not otherwise shown in FIG. 1. The solids phase 103 comprises solids while the light fluid phase 106 and the heavy fluid phase 109 comprise light liquids and heavy liquids, respectively.

The solid phase 103 may be removed from the slurry and directed through a solids discharge 112 of the centrifuge 100, whereafter the solids of the solid phase 103 may be collected, as will be explained in detail below. Similarly, light fluid phase 106 and heavy fluid phase 109 may be independently extracted from the slurry. A delineation between light fluid phase 106 and heavy fluid phase 109 may be determined based on, for example, a selected density or specific gravity that determines a cut point between the light fluid phase 106 and heavy fluid phase 109. This cut point may be adjusted based on operational requirements such as, for example, the type of slurry, additives in the slurry, a relative percentage of oil in the slurry, a relative percentage of water in the slurry, etc. The liquids (or, fluids) of the light fluid phase 106 and the heavy fluid phase 109 may then be independently collected and be disposed of, reintroduced into an operation, or otherwise used as a particular operation requires.

In order to determine and adjust a cut point between the light fluid phase 106 and heavy fluid phase 109, one or more sensors/monitors 115/118, may be disposed either within or outside centrifuge 100 to determine the ratio or percentages of oil to water in a particular light fluid phase 106 stream and/or and heavy fluid phase 109 stream. In this embodiment, a first sensor 115 is disposed in the light fluid phase 106 stream, while a second sensor 118 is disposed in the heavy fluid phase 109 stream. In other embodiments, a single sensor may be used, such as either first sensor 115 or second sensor 118. In still other embodiments, a single sensor may be disposed in contact with both the light phase fluid 106 stream and the heavy fluid phase 109 stream. Different types of sensors 115/118 may be used including, for example, density sensors. Those of ordinary skill in the art having the benefit of this disclosure will appreciate that any type of sensor 115/118 may be used that allows a relative ratio or percentage of oil to water within one or more of the light fluid phase 106 stream and/or and heavy fluid phase 109 stream to be determined.

Note that, in some embodiments, the feed pump may also be adjusted. As those in the art having the benefit of this disclosure will appreciate, the proportions of the heavy fluids phase and the light fluids phase in the feed slurry will also be a function of the feed pump operation. If a fluid needs to be adjusted this will happen by feedback from the sensors in either, or both of the liquid phases. The technique disclosed herein will, in some embodiments, take into account the feedback from the sensors and the flow from the feed pump to make the desired adjustments to set the fluid to the required specification.

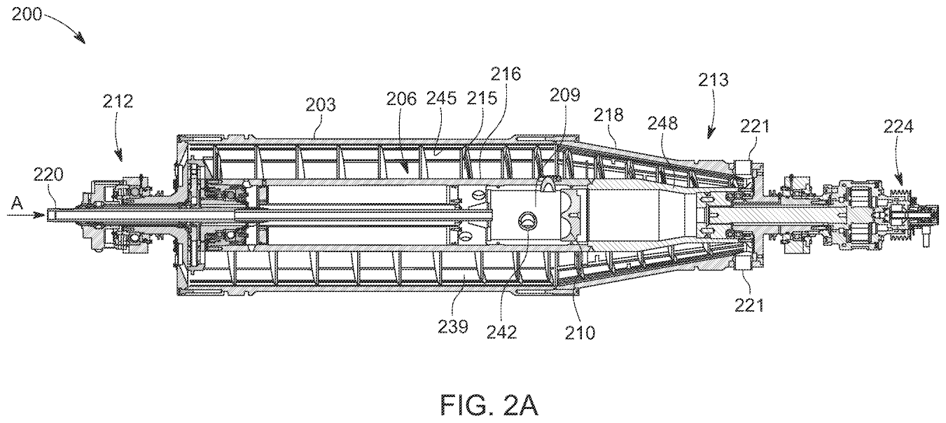

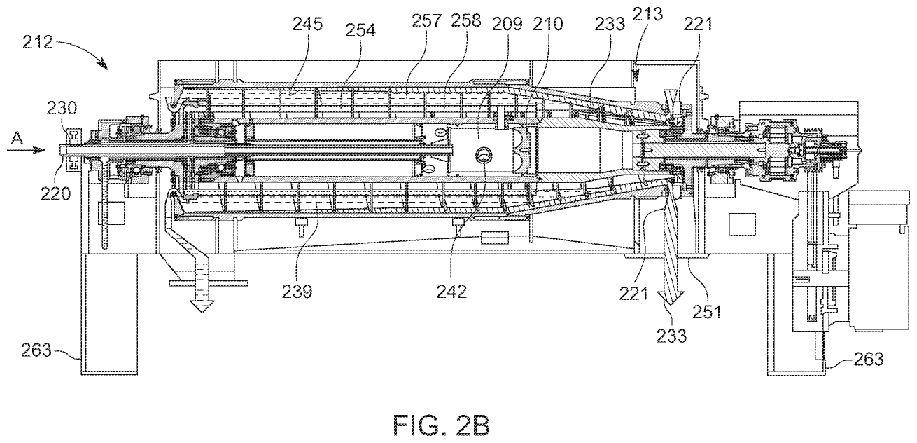

Referring to FIG. 2A, a cross-sectional view of a decanting three-phase centrifuge 200 according to embodiments of the present invention is shown. The centrifuge 200 is, in this particular embodiment, more particularly a decanting centrifuge. In this embodiment, a centrifuge 200 is shown having a bowl assembly 203 disposed around a conveyor 206. The bowl assembly 203 and/or conveyor 206 may be made from various materials include metals and metal alloys, plastics, and composites. For example, in one embodiment bowl assembly 203 and/or conveyor 206 may be made from stainless steel.

Conveyor 206 includes a plurality of flights 215 disposed upon a conveyor body 216. The plurality of flights 215 may be disposed between the bowl assembly 203 and the conveyor 206 as shown, controlling a flow of fluid therethrough. An accelerating chamber 209 is disposed within the conveyor body 209. The bowl assembly 203 further includes a conical end 218 and defines one or more ejection ports 221 disposed thereon. Centrifuge 200 further includes a pair of belt drive systems 224 that drive rotation of the bowl assembly 203 and the conveyor 206, respectively.

During operation, as shown in FIG. 2B, a fluid 230 enters the fluid inlet end 212 of the decanting three-phase centrifuge 200 through a feed inlet 220 under pressure. The fluid 230 may be laden with solids material 233 or other particulate matter is flowed through fluid inlet 236 in direction A into centrifuge 200. The fluid 230 may be a slurry containing a solids phase, a heavy fluid phase, and a light fluid phase as described above. The bowl assembly 203 and/or the conveyor 206 are rotated at desired speeds.

The fluid 230 enters the accelerating chamber 209 and strikes the back plate 210 and is diverted back into the accelerating chamber 209. As the bowl assembly 203 and the conveyor 206 rotate, the fluids 230 move from the accelerating chamber 209 into the annulus 239 between the bowl assembly 203 and the conveyor 206 through the ports 242 (only one indicated). The fluid 230 still comprises the solids phase, the heavy fluids phase, and the light fluids phase as the three phases have not yet been separated.

The differential speed between the bowl assembly 203 and the conveyor 206 causes the solids material 233 to accumulate along an inner wall 245 of the bowl assembly 203. The flights 215 of the conveyor 206 then move the separated solids material 233 up the bowl assembly 203 to an angled portion known in the art as a beach 248. The solids material 233 may then exit the bowl assembly 203 through the ports 221 and the centrifuge 200 through the solids phase discharge 251 and be collected for disposal or reuse. The separated fluid 254 flows under pressure in the opposite direction of solids material 233 and for further separation, disposal, or reuse in a manner described more fully below. Note that, at this point, the separated fluid 254 includes both heavy fluids 257 and light fluids 258.

The centrifuge 200 may be configured to remove solids of a particular density by adjusting one or more operating parameters of the centrifuge 200. In one embodiment, the angle of the flights 215 may be varied to control the separation of fluids 254 from solids material 233. In other embodiments, a pond depth may be controlled by adjusting dam plates 260. Pond depth refers to the fluid level between bowl assembly 203 and conveyor 206. In order to achieve a dryer solids material 233, dam plates 260 may be rotated out, thereby increase pond depth, which will result in the dryer solid portion. In another application, dam plates 260 may be rotated inward, thereby decreasing pond depth resulting in a less dry, or wetter, solids material 233.

Those of ordinary skill in the art having the benefit of this disclosure will appreciate that the rotation rates of the bowl assembly 203 and the conveyor 206 may vary according to operational requirements. In one embodiment, the bowl assembly 203 may rotate between 0 and 3000 revolutions per minutes (rpm). The conveyor 206 may rotate between 1 and 50 rpm. In certain embodiments, the bowl assembly 203 may rotate in the same direction as the conveyor 206, while in other embodiments bowl assembly 203 and conveyor 206 may rotate in the different directions. In still other embodiments, either the bowl assembly 203 or the conveyor 206 may be relatively stationary, while the other component rotates.

While centrifuge 200 illustrated in FIG. 2A is a decanting centrifuge, those of ordinary skill in the art having the benefit of this disclosure will appreciate that other types of separators, such as, for example, shakers or hydrocyclones may also be used to separate solids material 233 from fluids 254. These examples are illustrative only and the list is neither exclusive nor exhaustive.

Thus, separation of solids from the rest of the slurry occurs in the conical/cylindrical bowl assembly 203, which rotates at a pre-set speed, by action of the conveyor 206, which may also rotate at a pre-set speed. The slurry, which at this point comprises the separated fluids 254, once accelerated to the bowl speed, forms concentric layers of solids and fluids around the inside of the bowl. The solids in the slurry may then be deposited against the bowl wall due to centrifugal force. Also as discussed above, the conveyer 206 in this particular embodiment rotates at a differential speed relative to the bowl assembly 203, and as such, conveys separated solids 233 in the direction of the conical, forward end 213 of the bowl. The separated solids 233 may then be discharged through the ports 221 at the conical end 213 of the bowl assembly 203 and enter a stationary solids housing 251 of the casing 263 to be discharged from centrifuge 300 through the solids discharge 251. Note that FIG. 2B shows some parts of the decanting three-phase centrifuge 200 not shown in FIG. 2A, such as the stationary solids housing 251 and the casing 263.

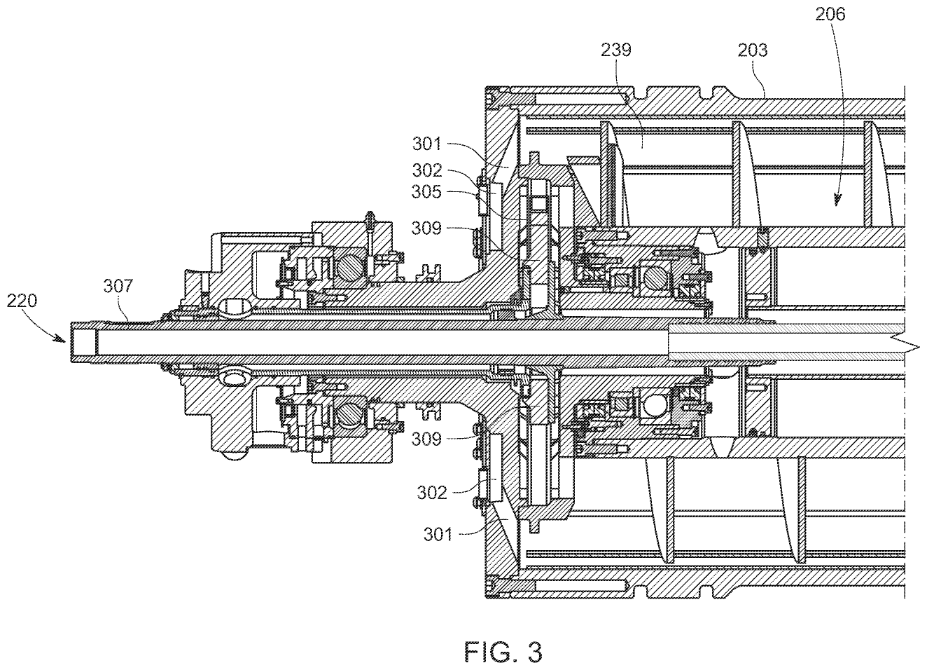

Referring collectively to FIG. 2B and FIG. 3, while the separated fluids 254 are being clarified, i.e., having the solids removed therefrom, the separated fluids 254 flow back toward the cylindrical end, or fluid inlet end 212, of the bowl assembly 203 in the annulus 239 as shown in FIG. 2B. The separated heavy fluids 254 exit the annulus 239 through the access tube 301, shown in FIG. 3, and overflow adjustable weir plates 302. The adjustable weir plates 302 determine the depth of the pond of fluids. The clarified fluids 254 may then be decanted into a chamber 305, also shown in FIG. 3, where the light fluid phase 258 and the heavy fluid phase 257, shown in FIG. 2B, may be separated based on, for example, their relative specific gravities. The light fluid phase 258 and the heavy fluid phase 257, e.g., oil and water phases, are separated and decanted through separate discharge systems as shown in FIG. 2B to prevent cross-contamination therebetween.

Referring now to FIG. 3, a cross-sectional view of a portion of a bowl assembly of the bowl assembly 203 of the centrifuge 200 in FIG. 2A and FIG. 2B, according to one or more examples of the disclosure is shown. The centrifuge 200, such as a decanting centrifuge, includes a feed inlet 220 through a feed tube 307 through which the three-phase slurry 230 including solids and fluids may be introduced through the fluids inlet 220. For the sake of clarity and so as not to obscure that which is claimed below, FIG. 3 does not show the slurry nor its constituent parts, the solids phase, the heavy fluid phase, and the light fluid phase.

In this embodiment, a paring disc 309 provides a pressure discharge for the light fluid phase. If the density difference or the quantity of the light fluid phase and the heavy fluid phase changes, paring disc 309 allows the interface between the two phases to be adjusted during operation to allow for an optimized purity of the two phases. As such, as the mix of solids and phases of fluids change over time, the position of paring disc 309 may be adjusted to provide optimal separation.

In conventional centrifuges, a user manually adjusts operational aspects of a centrifuge in response to changes in the solids and phases of fluids. As such, the user must manually observe changes to the slurry, the solids, and the phases of fluids, and manually adjust, for example, a position of a paring disc. Such manual manipulation thus requires the operator to constantly be present to monitor the operation and make adjustments as they deem appropriate. Due to the manual manipulation and user-based observation, there are not predictable results as to the purity of the separated solids, light fluid phase, and heavy fluid phase. Accordingly, a heavy fluid phase may include unacceptable percentages of oil and/or the light fluid phase may include unacceptable percentages of water.

Embodiments of the present disclosure provide for the substantially automated adjustment of paring disc 309 through use of an externally disposed actuator (not shown). In combination with sensors, such as those discussed above with respect to FIG. 2, and a control unit (not shown), which is discussed in detail below, paring disc 309 may be positioned to allow on the fly adjustments as slurry conditions change. Such automated actuation of paring disc 309 may thereby allow optimized purity in the solids, the light fluid phase, and the heavy fluid phase.

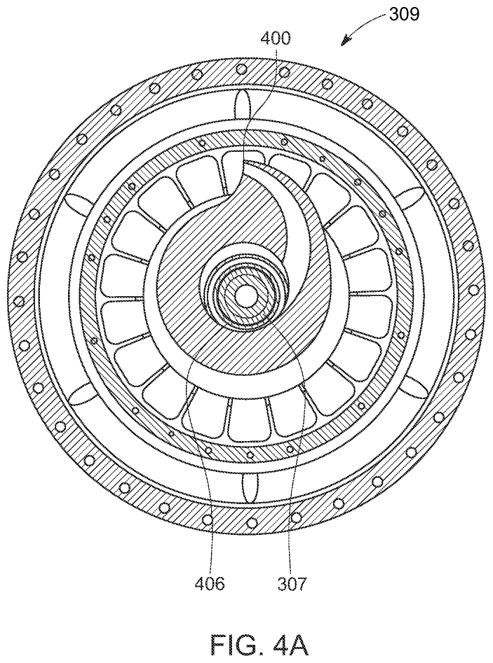

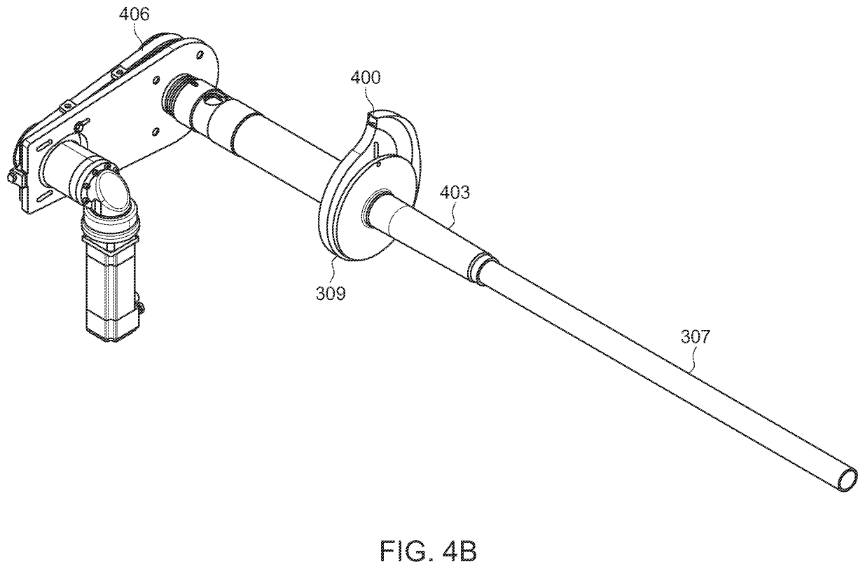

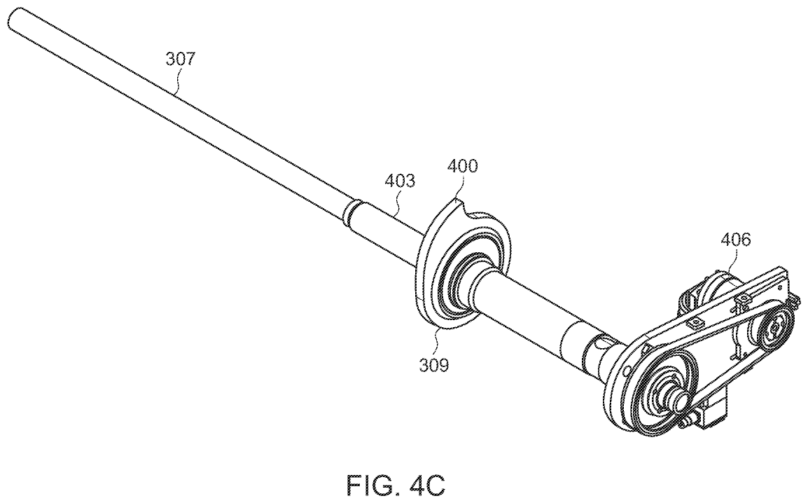

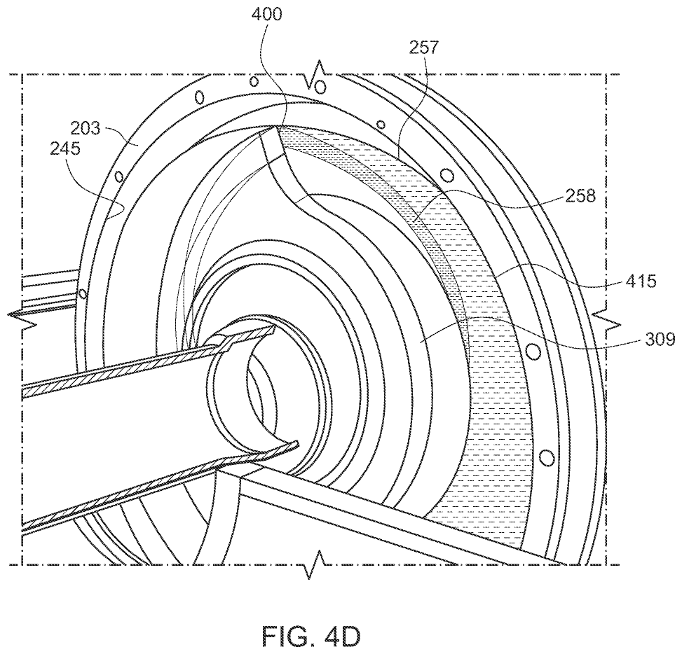

Referring briefly to FIGS. 4A-4C, a top, plan view of the paring disc 309 first shown in FIG. 3. In this embodiment, paring disc 309 is radially adjustable, thereby allowing the interface between the light fluid phase and the heavy fluid phase to be adjusted as operational conditions change. Not only is the position of the paring disc 309 radially adjustable, the radial adjustment is substantially automated an externally disposed actuator (not shown in FIG. 3). As shown therein, the paring disc 309 includes a tooth, or lip, 400 with which the paring disc 309 separates the light fluids phase from the heavy fluid phase. The paring disc 309 is mounted to a sleeve 403 fitted over the feeding tube 307. The rotation of the paring disc 309 is driven by the actuator 406.

FIG. 4D illustrates the separation of the light fluids phase 258 from the heavy fluids phase 257 for decanting and removal. As can be seen in FIG. 4D, the rotation of the bowl assembly 203 has separated the light fluids phase 258 from the heavy fluids phase 257 against the inner wall 245 of the bowl assembly 203. More particularly, the light fluids phase 258 and the heavy fluids phase 257 are separated by their respective densities, light fluids phase 258 forming the inner ring and the heavy fluids phase 257 forming the outer ring. The boundary between the light fluids phase 258 and the heavy fluids phase 257 is the cut point 415. It is desirable that the tooth 400 be positioned directly at the cut point 415 to skim the light fluids phase 258 from the heavy fluids phase 257.

Over time, the relative proportions of the light fluids phase 258 and the heavy fluids phase 257 may change. This will, in turn, change the location of the cut point 415. If the radial position of the tooth 400, and, hence, the paring disc 309 as a whole, is not changed, then the efficiency of the separation will suffer. If the tooth 400 is located too far inwardly in a radial direction, then there will be an undesirable amount of light fluids phase 259 in the separate heavy fluids phase 257. If the tooth 400 is located too far outwardly in a radial direction, then some heavy fluids phase 257 will be undesirably separated with the light fluids phase 258.

The avoid, or at least mitigate, these consequences, the presently disclosed technique automatically adjusts the radial position of the paring disc 309, and, thus, the tooth 400. In particular, the paring disc 309 rotates using a caroming motion. This cammed rotation thereby shifts the position of the tooth 400 so that the tooth 400 is positioned at the cut point 415 as the location of the cut point 415 changes over time. The change in the position of the cut point 415 can be detected from changes in some physical parameter of the separated light fluids phase 258 and/or the heavy separated fluids phase 257.

For example, again using density, the densities of the light fluids phase 258 and the heavy fluids phase 257. If the density of the separated light fluids phase 258 is too high, or if the density of the heavy fluids phase 257 is too light, then it can be assumed that the cut point 415 has shifted and that the radial position of the paring disc 309 should be shifted in order to bring them back to within acceptable ranges. This sensing and analysis are performed as described elsewhere herein.

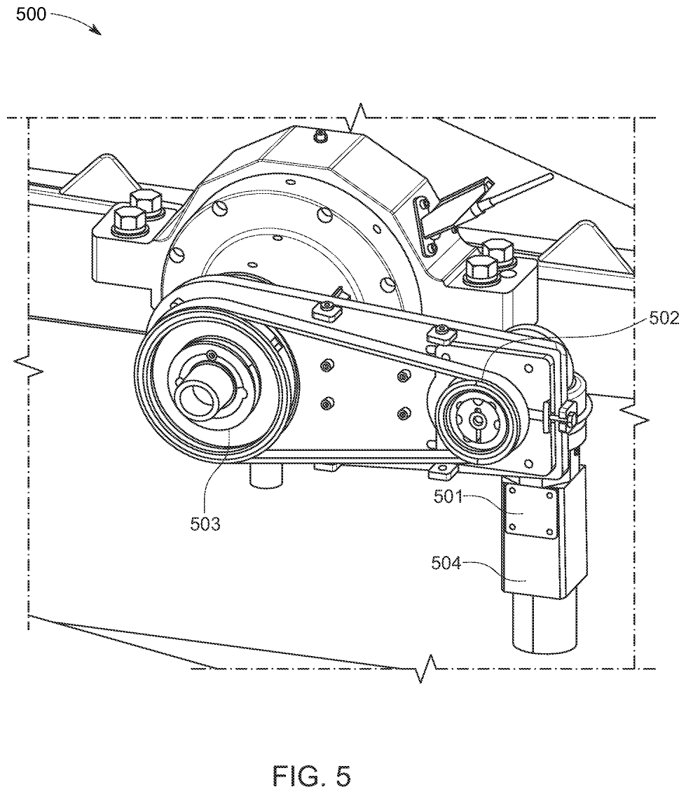

Referring now to FIG. 5, a side perspective view of an actuator 500 for a centrifuge according to one or more examples of the disclosure is shown. In this embodiment, an actuator 500 may include a motive device 501, such as an electric servo-motor, that is used to adjust the position of a paring disc, as described above. Motive device 501 may be connected to one or more belts 502 that allow a rotational position of a linkage 503 that connects the actuator 500 to the paring disc (e.g., paring disc 309 in FIGS. 3-4) to be adjusted. As the position of the linkage 503 changes, the radial position of the paring disc may be adjusted, thereby allowing the interface between the light fluid phase and the heavy fluid phase to be adjusted as operational conditions change.

In other embodiments, actuator 500 may include a motive device 501 that uses gears and pinions (not shown), rather than belts 502, to adjust a location of the paring disc. In certain embodiments, rather than a rotational position of linkage 503 adjusting the radial position of the paring disc, a longitudinal or lateral position of one or more components of actuator 500 may determine the radial position of the paring disc. In either embodiment, as a position of one or more components of actuator 500 changes, a corresponding position of the paring disc also changes.

The actuator 500 may further include a control unit 504. Feedback from the sensors, such as the sensors 115/118 discussed above with respect to FIG. 1, goes to a programmable logic controller (“PCL”, not shown in FIG. 5) that will determine the adjustment needed and send a signal to the control unit 504The instruction from the PLC allows the control unit 504 to determine a current operating condition of a decanting three-phase centrifuge. As control unit 504 receives input from the PLC, such as a density, specific gravity, etc., the PLC with feedback from the sensors will send a signal to the control unit 504 which will alter the position of paring disc to optimize the separation of solids, the light fluid phase, and the heavy fluid phase. For example, if a specific gravity of the light fluid phase is too high, the PLC may instruct 504 may instruct actuator 500 to adjust the paring disc to decrease the specific gravity of the light fluid phase. Similarly, if a specific gravity of the heavy fluid phase is lower than desired or expected, control unit 504 may instruct actuator 500 to adjust the position of the paring disc to allow for an optimized specific gravity of the heavy fluid phase.

Those of ordinary skill in the art having the benefit of this disclosure will appreciate that the sensors may substantially constantly monitor the condition of one or more of the light fluid phase and the heavy fluid phase, thereby allowing operating parameters to be adjusted in real time or substantially real time. In certain embodiment, the sensors may monitor one or more properties of the light fluid phase and/or the heavy fluid phase every second, every fraction of a section, every minute, or according to a time interval as determined based on the operational requirements of the process. For example, in certain operations, the properties of the light fluid phase and/or the heavy fluid phase may require more frequent monitoring, while in other operations, relatively long periods of time may be allowed before sensors take readings/measurements of properties of the fluid phases.

Control unit 504 may be pre-programmed and/or provide various operating parameters that allow for adjustment to actuator 500 and the paring disc during operation. Examples of operating parameters may include a bowl speed, differential speed, pump position, feed rate, feed temperature, feed temperature set point, temperature ranges, and the like. Control unit 504 may thereby use sensor inputs to generate operational outputs that include, for example, a location of a paring disc that allows for light fluid phase and/or heavy fluid phase optimization. Control unit 504 may also receive one or more fluid parameters from, for example, one or more sensors. Fluid parameters may include, for example, a density, a specific gravity, or the like. By using the fluid parameters and/or operating parameters, control unit 504 may adjust the paring disc into a position to allow for fluid separation optimization. Other aspects of control unit 504 will be discussed below.

In one particular embodiment, the sensed fluid parameter is the density of the sensed fluid. The light fluid phase and the heavy fluid phase have characteristic densities and, so, the measured densities may be able to indicate an improperly set cut point. For instance, if the density of a heavy fluid phase if lower than expected, this may indicate the presence of light fluids in the separated heavy fluid phase. Similarly, if the light fluid phase has a higher than expected density, this may indicate the presence of heavy fluids in the separate light fluid phase. The cut point can then be reset to more precisely separate the light fluid phase from the heavy fluid phase.

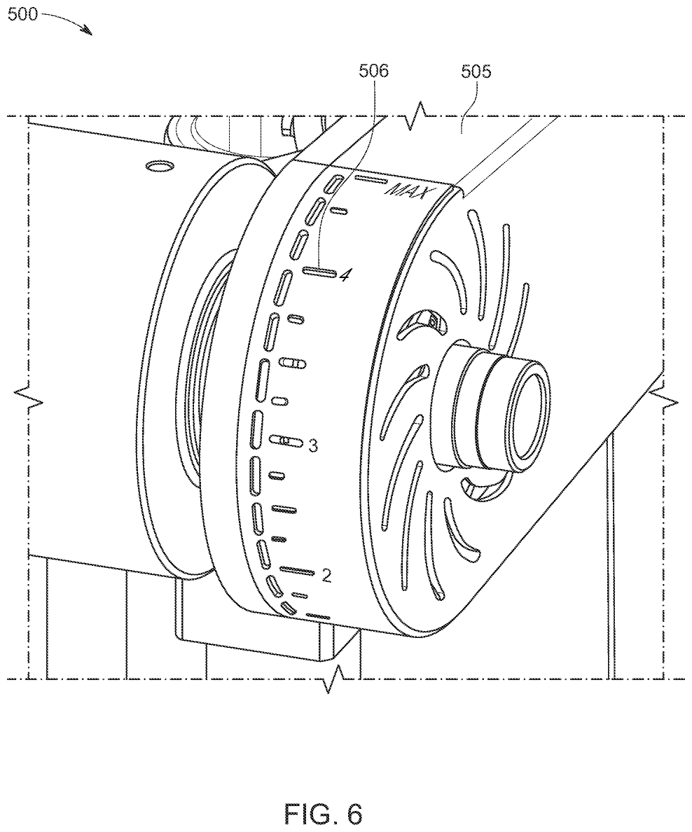

Referring to FIG. 6, a side view of the actuator 500 of FIG. 5 for a centrifuge, according to one or more examples of the disclosure is shown. The actuator 500 of FIG. 5 is shown in FIG. 6 having a cover 505 disposed thereon. Cover 505 may include various markings indicative of a position of a paring disc. In this embodiment, cover 505 includes a marking such as “MAX”, 4, 3, 2, etc., which represent a relative location of a paring disc. As actuator 500 adjusts the position of the paring disc, an indicator 506 may be illuminated or otherwise inform an operator of a centrifuge the location of the paring disc. In this example, indicator 506 indicates that the paring disc is at a relative location just below 4.

As actuator 500 rotates, indicator 506 may move into a location indicative of a corresponding paring disc position. As such, an operator may know the position of the paring disc without having to access a control unit or other operational components of the centrifuge. Those of ordinary skill in the art having the benefit of this disclosure will appreciate that indicator 506 is one type of indicator that may be used. In other embodiments, indicator 506 may be a light, such as a light emitting diode (“LED”), a physical component, such as a lever or tab, a display on a monitor, or any other indicator 506 that informs an operator as to the position of the paring disc.

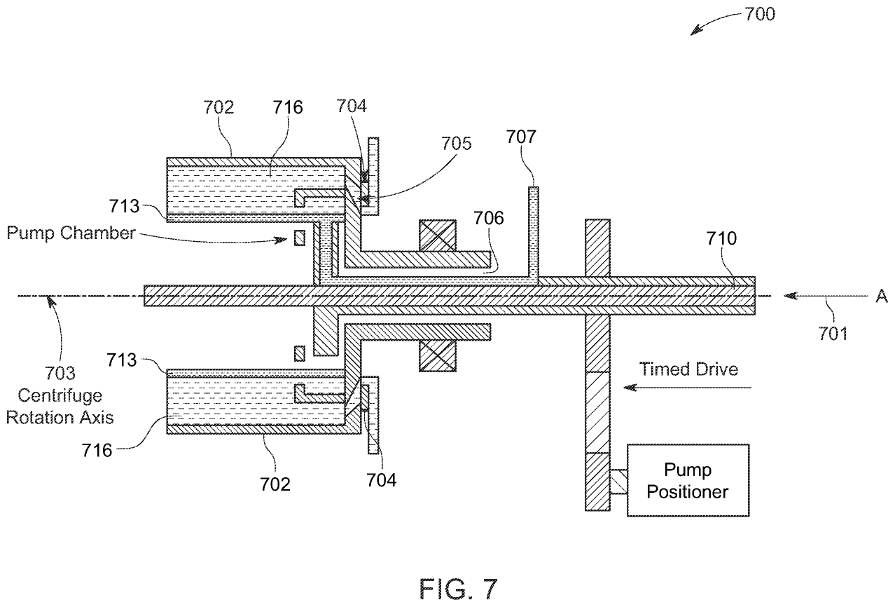

Referring to FIG. 7, a schematic representation of a centrifuge is shown in a sectioned view, according to one or more examples of the disclosure is shown. In this example, a centrifuge 700 is shown that allows for solids, light fluid phases, and heavy fluid phases to be separated from a slurry. During operation, a slurry 710 is fed through a feed inlet 701 and into a bowl 702 as the bowl 702 rotates about a centrifuge axis 703 the solids are separated from the fluid phases, as described above. The solids may then exit centrifuge 700 through a solids discharge (not shown in FIG. 7), as illustrated and explained above with respect to FIGS. 1 and 2.

The aforementioned centrifugal action allows for separation and classification of the different phases of the fluid remaining after the solids are separated out. A lighter phase fluid 713, which is typically oil, forms an inner annulus concentric to the bowl 702 axis of rotation. The heavier phase fluid 716 forms an outer annulus also concentric to the bowl 702 axis of rotation. The heavy phase fluid 716 may then flow through over an adjustable weir 704. In this example, the adjustable weir 704 comprises one or more weir plates and two weir plates are shown. In other embodiments, one weir plate or more than two weir plates may be used. The heavy fluid phase 716 may then exit centrifuge 700 through a heavy fluid phase outlet 705.

The light fluid phase 713 may flow into a paring pump chamber 706. Paring pump chamber 706 includes a paring disc (not independently shown in FIG. 7), such as those discussed above with respect to FIGS. 3-4, which allows for collection of the light fluid phase 713. The light fluid phase 713 may then exit centrifuge 700 by flowing out of a light fluid phase outlet 707. In this particular embodiment, a centripetal pump 721 pumps the light fluid phase 713 from the centrifuge 700.

The above discussed centrifuge and components thereof may be used in methods and processes for separating solids, light fluid phases, and heavy fluid phases. During the process, various other components, such as pumps, valves, containers, and the like may also be used. Before discussing the process in detail, a brief introduction to other process components is provided below.

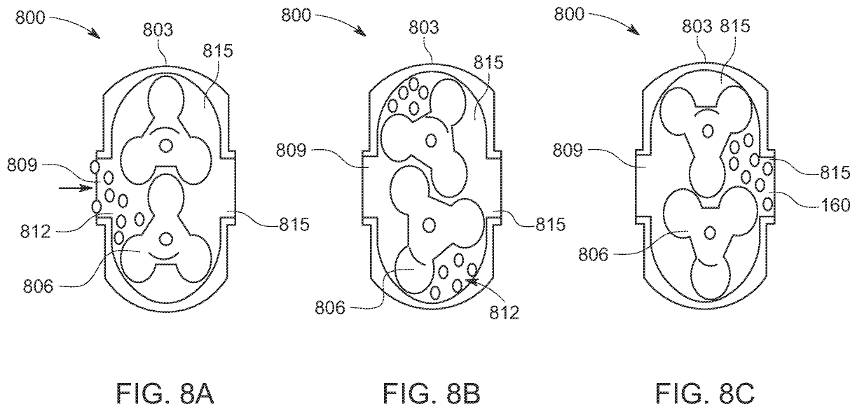

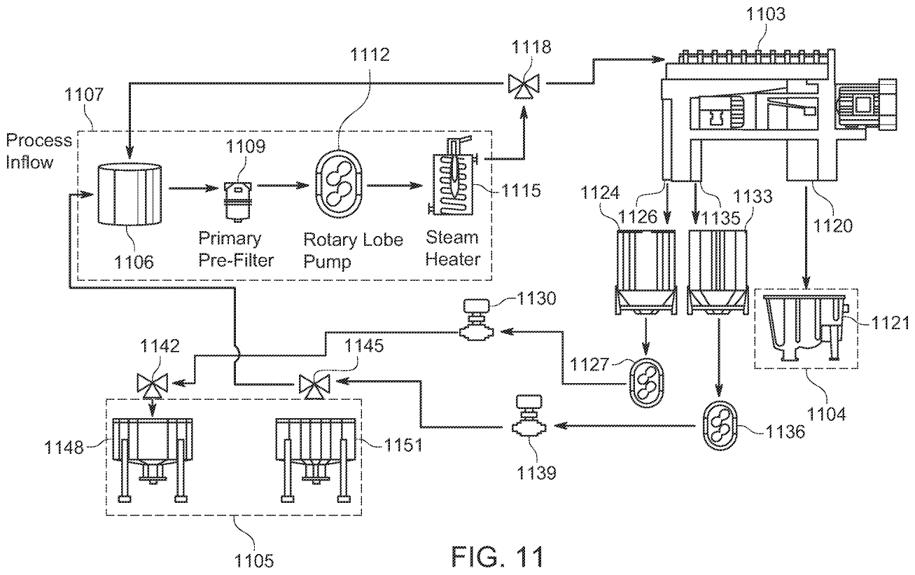

Referring to FIGS. 8A-8C, schematic cross-sectional views of a rotary pump 800 according to embodiments of the present invention are shown. The pump 800 may be used in a fluid optimization system, such as the one shown in FIG. 11 and discussed below. In certain embodiments, a fluid optimization system may employ a decanting three-phase centrifuge such as those discussed above.

Different types of pumps may be used according to embodiments. One type of pump 800 that may be used is a rotary lobe pump 800, which is shown in three phases of operation in FIGS. 8A-8C. Generally, rotary lobe pump 800 has a body 803 and two lobes 806. As shown in FIG. 8A, as lobes 806 rotate out of meshing, a fluid containing solids 812 is pulled into body 803 through inlet port 165. The fluid 809, a slurry containing solids 812, travels around the interior 815 of the body 803 in the pockets defined between the lobes 806 and the body 803 as shown in FIG. 8B. Finally, as shown in FIG. 8C, the meshing of the lobes 806 forces the fluid 809 containing solids 812 through an outlet port 815 under pressure.

In other embodiments, other types of pumps 800 may be used. In one embodiment, a centrifugal pump (not shown) may be used. In a centrifugal pump, an impeller in combination with a shaped pump housing applies centrifugal force to discharge fluids from the pump. Examples of other suitable pumps include general positive displacement pumps, duplex pumps, triplex pumps, jet pumps, etc. Those of ordinary skill in the art having the benefit of this disclosure will appreciate that any type of pump used in hydrocarbon production operations may be used according to embodiments of the present invention.

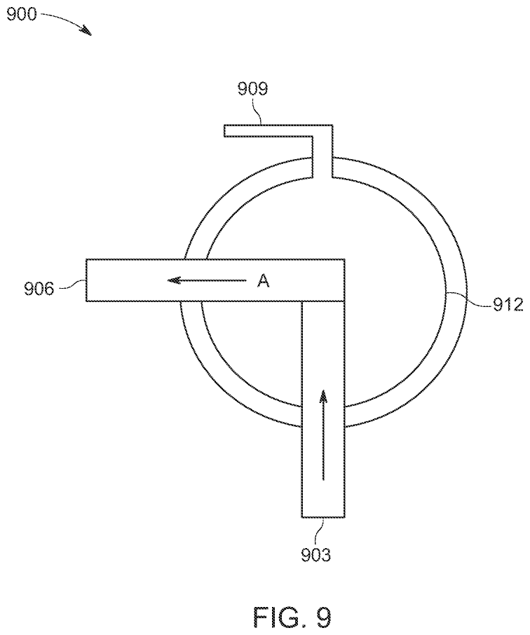

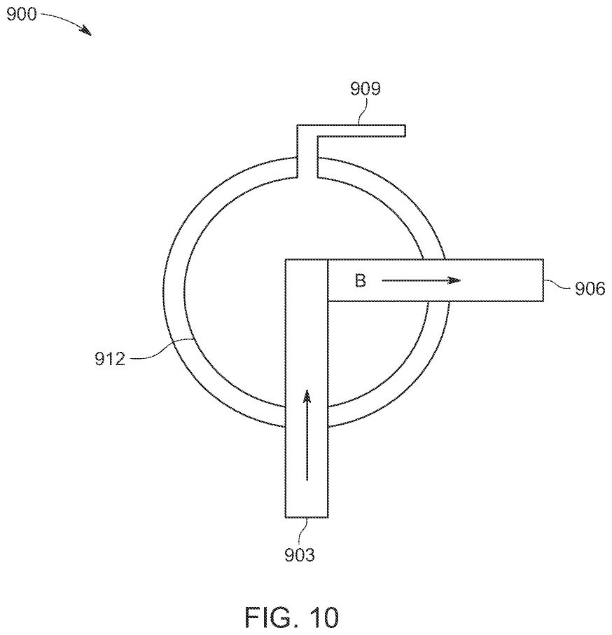

Referring now to FIGS. 9-10 together, side cross-sectional views of a three-way ball valve 900 according to embodiments of the present invention is shown. Such valves may be used in various embodiments to control the fluid flow through a fluid optimizations system such as the one shown in FIG. 11 and discussed below. Further, as will be discussed more fully below, such valves may be automatically controlled in some embodiments. Note, however, that, in addition to ball valves 900, other types of valves 900 may be used in various embodiments of the present disclosure. In another embodiment, valves may include different types of hydraulic, pneumatic, manual, solenoid, and or motor driven valves.

A three-way valve 900 allows the flow of a fluid through a system to be routed in two different directions. Referring specifically to FIG. 9, ball valve 900 may further include an inlet port 903 and an outlet port 906. During operation, a fluid may flow into ball valve 900 through inlet port 903. The fluid may continue to flow in direction A and exit ball valve 900 through outlet port 906. When the direction of the fluid within a system is rerouted, the handle 909 may be rotated into a different position, thereby turning inner disc 912 and changing the flow path of the fluid within ball valve 900. Referring specifically to FIG. 10, in a second position, the fluid may flow into ball valve 900 through inlet port 903. The fluid may continue to flow in direction B and exit ball valve 900 through outlet port 906.

Those of ordinary skill in the art having the benefit of this disclosure will also appreciate that valves 900 may actuate between different positions manually and/or automatically. In one embodiment, valves 900 may be connected to a control unit (not shown in FIGS. 9-10), such that actuation of the valve 900 may be automatically controlled. The actuation of valves 900 may be in response to a calculated fluid parameter, such as a density, as explained above. Thus, valve 900 may be used to change the fluid flow in a system, thereby allowing an optimized density for a fluid to be provided. Valves 900 may be connected to the control unit through either conventional wire-based systems or may be connected wirelessly.

Referring to FIG. 11, a schematic representation of a process flow for a fluid optimization system 1100, according to one or more examples of the disclosure. The fluid optimization system 1100 includes a slurry delivery system 1101, a decanting three-phase centrifuge 1103, a separated phases collection system 1104, 1105, and a flow control system 1107. The slurry delivery system1101 delivers a slurry including solids phase, a heavy fluid phase, and a light fluid phase to the decanting three-phase centrifuge 1103 for separation. The separated phases collection system 1104, 1105 collects the separated phases from the decanting three-phase centrifuge 1103. The flow control system 1107 controls the flow of fluids through the fluid optimization system 1100, including from the slurry delivery system 1101 to the decanting three-phase centrifuge 1103 and from the decanting three-phase centrifuge 1103 to the separated phases collection system 1104, 1105.

In this embodiment, a centrifuge 1103, such as those discussed above relative to FIGS. 1, 3, and 7, may be used to separate solids, a light fluid phase, and a heavy fluid phase. In operation, a feed tank 1106 may be used to store and/or provide a slurry (not separately shown) to the system 1100. The slurry may include a mixture of solids, water, oil, additives, and other various components that may be used or processed during various operations.

Feed tank 1106 may allow for the transfer of the slurry to a primary pre-filter 1109. Primary pre-filter 1109 may include a strainer or other components that allow for certain sized particles to be removed from the slurry. For example, primary pre-filter 1109 may be used to remove solids that are larger than about 3 mm. In other embodiments, the filtering size of primary pre-filter 1109 may be adjusted to allow different sized solids to be separated from the rest of the slurry. In one embodiment, primary pre-filter 1109 may be adjusted to remove, for example, solids greater than 1 mm, 2 mm, or larger than 3 mm.

After the slurry passes through primary pre-filter 1109, the slurry may be pumped using a feed pump 1112. The feed pump 1112 may be, for example, the pump described above with respect to FIGS. 8A-80 although other embodiments may employ other types of pumps as discussed above. The slurry may then be feed into a heat exchanger 1115. Heat exchanger 1115 may heat the slurry to a pre-set value. The pre-set value may vary depending on operational requirements. In certain embodiments, the slurry may be heated to between about 185° F. and about 190° F.

After being heated, the slurry may be transferred through one or more valves 1118 to centrifuge 1103. The valve 1118 may be a three-way ball valve such as the ball valve shown in FIGS. 9-10 and discussed above although alternative embodiments may employ alternative valves also as discussed above. Valve 1118 may be used to recirculate the slurry back into feed tank 1106 or may be adjusted to control the feed rate of the slurry into centrifuge 1103. The slurry may then be processed by centrifuge 1103 to separate a solid, a light fluid phase, and a heavy fluid phase. The solids may exit centrifuge 1103 through a solid discharge (not independently shown) and be collected in a solids collection tank 1121.

The light fluid phase is collected in a tank or reservoir 1124 and may be discharged through a light fluid phase discharge (not independently shown) via a centripetal pump 1127. The light fluid phase may then flow through one or more sensors 1130, such as those discussed above. Sensor 1130 may measure one or more fluid properties of the light fluid phase and send the fluid properties in the form of a fluid parameter, e.g., a light phase fluid parameter, to a control unit (not independently shown). The control unit may be, for example, the control unit 504, shown in FIG. 5.

The control unit may then determine if the fluid property reported by the sensor 1130 is within an acceptable range. If the fluid property is within an acceptable range, no further action may be taken. If the fluid property is not within an acceptable range, one or more operating parameters may be adjusted. For example, as described above, a paring disc (not independently shown) in centrifuge 1103 may be adjusted to change a cut point of the fluid flow, thereby allowing for light fluid phase and heavy fluid phase optimization.

Similarly, heavy fluid phase may be collected in a tank or reservoir 1133 and discharged through a heavy fluid phase discharge (not independently shown) via a centripetal pump 1136. The heavy fluid phase may then flow through one or more sensors 1139, such as those discussed above. Sensor 1139 may measure one or more fluid properties of the heavy fluid phase and send the fluid properties in the form of a fluid parameter, e.g., a heavy phase fluid parameter, to a control unit (not independently shown). The control unit may be, for example, the control unit 504, shown in FIG. 5. The control unit may then determine if the fluid property reported by the sensor 1139 is within an acceptable range. If the fluid properties are within an acceptable range, no further action may be taken.

Additionally, sensors 1127 and 1139 may allow the system to take additional actions if the fluid properties are not within acceptable ranges. For example, one or more valves 1142 and 1145 may be adjusted to direct the flow of light fluid phase and/or heavy fluid phase to different locations. Valve 1142 may be used to direct light fluid phase to a storage tank 1148 or may direct the light fluid phase back to feed tank 1106 for reprocessing. Similarly, valve 1145 may be used to direct heavy fluid phase to a storage tank 1151 or may direct the heavy fluid phase back to feed tank 1106 for reprocessing.

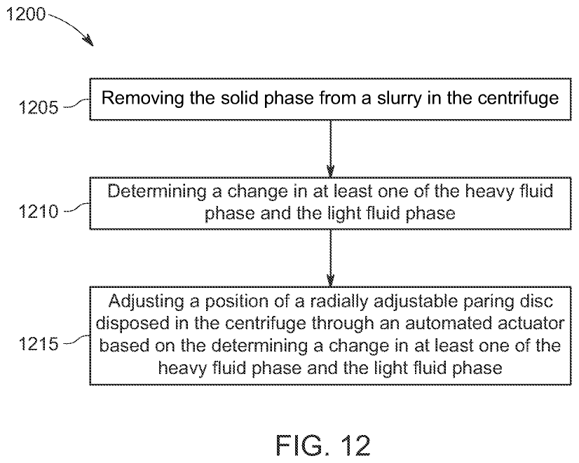

Referring to FIG. 12, a flow chart of a method of separating (block 1200) a solid phase, a heavy fluid phase, and a light fluid phase in a centrifuge according to embodiments of the present disclosure is shown. In operation, the method may include removing (block 1205) the solid phase from a slurry in the centrifuge.

In operation, the method may further include determining (block 1210) a change in at least one of the heavy fluid phase and the light fluid phase.

In operation, the method may further include adjusting (block 1215) a position of a radially adjustable paring disc disposed in the centrifuge through an automated actuator based on the determining a change in at least one of the heavy fluid phase and the light fluid phase.

In certain embodiments, in operation, the method may further include determining comprises detecting a fluid parameter of at least one of the heavy fluid phase and the light fluid phase. In certain embodiments, the fluid parameter may comprise a density of at least one of the heavy fluid phase and the light fluid phase.

In certain embodiments, in operation, the determining may comprise detecting a fluid parameter of the heavy fluid phase and the light fluid phase and based on the detecting, adjusting a longitudinal position of the radially adjustable paring disc that corresponds to the position of the radially adjustable paring disc.

In still other embodiments, in operation, the position of the radially adjustable paring disc is controlled from outside a bowl assembly of the centrifuge.

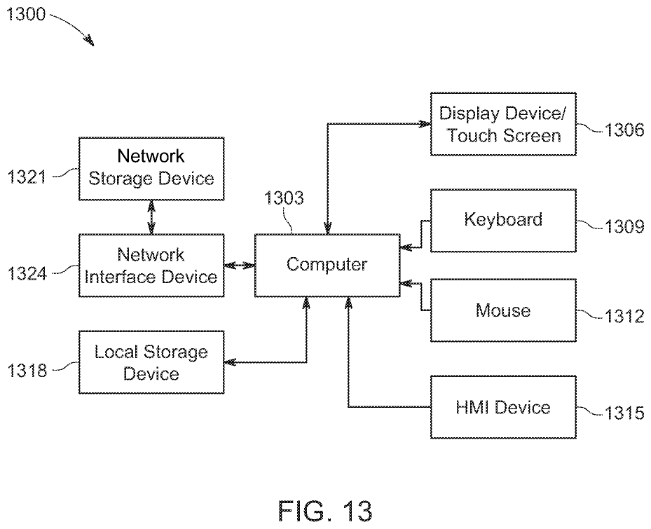

Referring to FIG. 13, a schematic representation of a control unit, such as the programmable logic controller discussed above, according to embodiments of the present disclosure is shown. The control unit may generally be a computing system 1300 in accordance with one or more embodiments of the present invention. Computing system 1300 may include one or more computers 1303 that each includes one or more printed circuit boards (not shown) or flex circuits (not shown) on which one or more processors (not shown) and system memory (not shown) may be disposed. Each of the one or more processors (not shown) may be a single-core processor (not shown) or a multi-core processor (not shown). Multi-core processors (not shown) typically include a plurality of processor cores (not shown) disposed on the same physical die or a plurality of processor cores (not shown) disposed on multiple die that are disposed in the same mechanical package.

Computing system 1300 may include one or more input/output devices such as, for example, a display device 1306, keyboard 1309, mouse 1312, and/or any other human-machine interface device 1315. The one or more input/output devices may be integrated into computer 1303. Display device 1306 may be a touch screen that includes a touch sensor (not shown) configured to sense touch. A touch screen enables a user to control various aspects of computing system 1300 by touch or gestures. For example, a user may interact directly with objects depicted on display device 1306 by touch or gestures that are sensed by the touch sensor and treated as input by computer 1303.

Computing system 1300 may include one or more local storage devices 1318. Local storage device 1318 may be a solid-state memory device, a solid-state memory device array, a hard disk drive, a hard disk drive array, or any other non-transitory computer readable medium. Local storage device 1318 may be integrated into computer 1303. Computing system 1300 may include one or more network interface devices 340 that provide a network interface to computer 1303. The network interface may be Ethernet, Wi-Fi, Bluetooth, WIMAX, Fibre Channel, or any other network interface suitable to facilitate networked communications.

Computing system 1300 may include one or more network-attached storage devices 1321 in addition to, or instead of, one or more local storage devices 1318. Network-attached storage device 1321 may be a solid-state memory device, a solid-state memory device array, a hard disk drive, a hard disk drive array, or any other non-transitory computer readable medium. Network-attached storage device 1321 may not be co-located with computer 1303 and may be accessible to computer 1303 via one or more network interfaces provided by one or more network interface devices 1324. One of ordinary skill in the art will recognize that computer 1303 may be a server, a workstation, a desktop, a laptop, a netbook, a tablet, a smartphone, a mobile device, and/or any other type of computing system in accordance with one or more embodiments of the present invention.

The control unit may be connected to various other components within a fluid density optimization system, as disclosed above. Examples of components that may be connected to and/or controlled at least in part by control unit include valves, meter, sensors, tanks, separators, pumps, and components thereof. The various components may be connected to the control unit through either conventional wire-based systems or they may be connected wirelessly. Those of ordinary skill in the art will appreciate that embodiments of the present invention may include one or more control units and the control units, in addition to the individual components described above, may further include various additional components not explicitly recited herein.

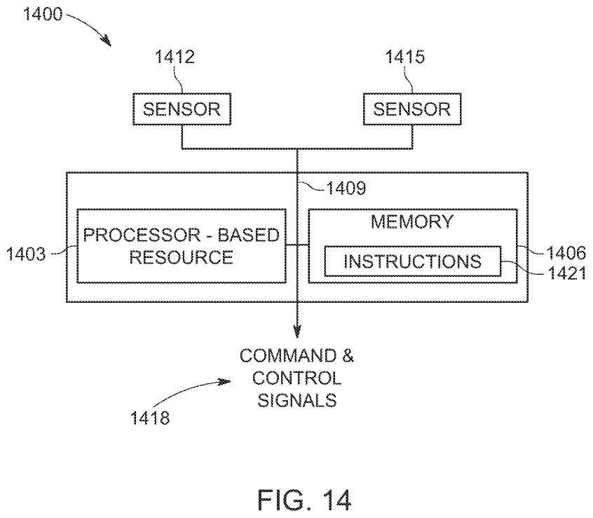

FIG. 14 illustrates one particular implementation of the control unit 504 discussed above. The control unit 1400 includes a processor-based resource 1403 and a memory 1406 communicating over a bus system 1409. The memory 1409 is encoded with instructions 1421 that, when executed by the processor-based resource 1403, cause the processor-based resource 1403 to execute the functionality of the control unit 1400. The control unit 1400 may receive signals from one or more sensors 1412, 1415 as discussed above relative to FIG. 2 as well as the programmed logic controller, also as discussed above. The control unit 1400 may also process signals input from the sensors 1412, 1415 as discussed above to generate command and control signals 1418 to the centrifuge.

The command and control signals 1418 may include signals controlling the radial adjustment of the paring disc (not separately shown in FIG. 14) as described above responsive to the inputs from the sensors 1412, 1415 and/or the programmed logic controller. The command and control signals 1418 may include signals setting various operating parameters of the centrifuge. Examples of such operating parameters for the centrifuge may include, without limitation, a bowl speed, differential speed, pump position, feed rate, feed temperature, feed temperature set point, temperature ranges, and the like. The command and control signals 1418 may also include control signals for valves in a fluid optimization system, such as the control valves 1118, 1142, 1145 of the fluid optimization system 1100 in FIG. 11 in some embodiments. Note, however, that control of centrifuge operating parameters and flow control valves may also be separated into other control units in other embodiments, such as the programmed logic controller.

The processor-based resource 1403 may be any suitable kind of processor or set of processors known to the art. The term “processor” has an understood, known structural connotation in the art. Processors may include, for example, and without limitation, controllers, microcontrollers, microprocessors, digital signal processors, and/or math co-processors. Processors may also include integrated circuits such as Application Specific Integrated Circuits (“ASICs”), Electrically Programmable Read Only Memories (“EPROMs”), Electrically Erasable Programmable Read Only Memories (“EEPROMs”), and others. The processor-based resource 1403 may be any one of these, and combination of these, or some type of processor known to the art.

The memory 1406 may be on-chip or off-chip depending on the implementation. For instance, the instructions 1421 may be encoded on-chip as firmware or off-chip as an application. The instructions 1421 may also be programmed into, for example, an ASIC, EEPROM, or EPROM. The subject matter claimed below admits wide variation in implementation.

Examples in the present disclosure may also be directed to a non-transitory computer-readable medium storing computer-executable instructions and executable by one or more processors of the computer via which the computer-readable medium is accessed. A computer-readable media may be any available media that may be accessed by a computer. By way of example, such computer-readable media may comprise Random Access Memory (“RAM”), Read Only Memory (“ROM”), EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (“CD”), laser disc, optical disc, digital versatile disc (“DVD”), floppy disk and Blu-ray® disc where disks usually reproduce data magnetically, while discs reproduce data optically with lasers.

Note also that the software implemented aspects of the subject matter claimed below are usually encoded on some form of program storage medium or implemented over some type of transmission medium. The program storage medium is a non-transitory medium and may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The claimed subject matter is not limited by these aspects of any given implementation.

The embodiments disclosed herein are all disclosed in the context of hydrocarbon production operations. However, those in the art having the benefit of this disclosure will appreciate that the subject matter claimed below is not so limited. The embodiments disclosed and claimed herein by be used in any three-phase separation process.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A decanting three-phase centrifuge comprising:
a rotatable bowl defining a paring pump chamber;
a radially adjustable paring disc disposed within the paring pump chamber of the rotating bowl to provide a cut point between a heavy fluid phase and a light fluid phase of a slurry and thereby separate the light fluid phase from the heavy fluid phase;
an actuator disposed outside the rotatable bowl to radially adjust the position of the paring disc;
at least one sensor to sense a fluid parameter of a first one of the separated heavy fluid phase and the separated light fluid phase and output a fluid parameter signal representative of the sensed fluid parameter;
a control unit programmed to, on the fly:
receive the fluid parameter signal from the at least one sensor;
determine from the received fluid parameter signal whether the cut point is to be adjusted; and
if the cut point is to be adjusted, automatically drive the actuator to radially adjust the paring disc and thereby reset the cut point on the fly while the centrifuge is operating.

2. The decanting three-phase centrifuge of claim 1,
further comprising a second sensor to sense a second fluid parameter of a second one of the separated heavy fluid phase and the separated light fluid phase and output a second fluid parameter signal representative of the sensed second fluid parameter; and
wherein the determining whether the cut point is to be adjusted includes determining from the received second fluid parameter signal in conjunction with the received first fluid parameter signal whether the cut point is to be adjusted.

3. The decanting three-phase centrifuge of claim 1, wherein the actuator includes:
a motive device driven by the control unit;
a rotating linkage to the paring disc whose rotation radially adjusts the position cut point provided by the paring disc.

4. The decanting three-phase centrifuge of claim 3, wherein the motive device rotates the linkage by action of one or more belts or by [symbol] ears and pinion.

5. The decanting three-phase centrifuge of claim 1, wherein the control unit is further programmed to control predetermined centrifuge parameters.

6. The decanting three-phase centrifuge of claim 1, wherein the centrifuge parameters include a bowl speed, a differential speed, a feed rate, a temperature, or combinations thereof.

7. A fluid optimization system, comprising:
a slurry delivery system delivering a slurry including solids phase, a heavy fluid phase, and a light fluid phase;
a decanting three-phase centrifuge receiving the slurry from the slurry delivery system, the decanting three-phase centrifuge further comprising:
a rotatable bowl defining a paring pump chamber;
a radially adjustable paring disc disposed within the paring pump chamber of the rotating bowl to provide a cut point between a heavy fluid phase and a light fluid phase of a slurry and thereby separate the light fluid phase from the heavy fluid phase;
an actuator disposed outside the rotatable bowl to radially adjust the position of the paring disc;
at least one sensor to sense a fluid parameter of a first one of the separated heavy fluid phase and the separated light fluid phase and output a fluid parameter signal representative of the sensed fluid parameter;
a control unit programmed to, on the fly:
receive the fluid parameter signal from the at least one sensor;
determine from the received fluid parameter signal whether the cut point is to be adjusted; and
if the cut point is to be adjusted, automatically drive the actuator to radially adjust the paring disc and thereby reset the cut point on the fly while the centrifuge is operating;
a separated phases collection system to collect the separated phases from the decanting three-phase centrifuge; and
a flow control system to control the flow of fluids through the fluid optimization system, including from the slurry delivery system to the decanting three-phase centrifuge and from the decanting three-phase centrifuge to the separated phases collection system.

8. The fluid optimization system of claim 7,
further comprising a second sensor to sense a second fluid parameter of a second one of the separated heavy fluid phase and the separated light fluid phase and output a second fluid parameter signal representative of the sensed second fluid parameter; and
wherein the determining whether the cut point is to be adjusted includes determining from the received second fluid parameter signal in conjunction with the received first fluid parameter signal whether the cut point is to be adjusted.

9. The fluid optimization system of claim 8, wherein the actuator includes:
a motive device driven by the control unit;
a rotating linkage to the paring disc whose rotation radially adjusts the position cut point provided by the paring disc.

10. The fluid optimization system of claim 3, wherein the motive device rotates the linkage by action of one or more belts or by gears and pinion.

11. The fluid optimization system of claim 7, wherein the control unit is further programmed to control predetermined centrifuge parameters.

12. The fluid optimization system of claim 7, wherein the centrifuge parameters include a bowl speed, a differential speed, a feed rate, a temperature, or combinations thereof.

13. The fluid optimization system of claim 7, wherein the control unit is further programmed to control fluid flow through the fluid optimization system.

14. A method of separating a solid phase, a heavy fluid phase, and a light fluid phase from a slurry in a decanting three-phase centrifuge, the method comprising:
removing the solid phase from a slurry in the decanting three-phase centrifuge;
separating the light fluid phase from the heavy fluid phase in the decanting three-phase centrifuge at a cut point;
monitoring at least one of the separated heavy fluid phase and the separated light fluid phase, including transmitting a fluid parameter signal representative of a sensed fluid parameter of at least a first one of the separated heavy fluid phase and the separated light fluid phase;
receiving the fluid parameter signal from the at least one sensor;
determining from the received fluid parameter signal whether the cut point is to be adjusted; and
if the cut point is to be adjusted, automatically radially adjusting the position of the paring disc in the decanting three-phase centrifuge and thereby reset the cut point on the fly while the decanting three-phase centrifuge is operating.

15. The method of claim 14, wherein determining from the received fluid parameter signal whether the cut point is to be adjusted includes determining a change in at least one of the separated heavy fluid phase and the separated light fluid phase.

16. The method of claim 14,
further comprising monitoring the other one of the separated heavy fluid phase and the separated light fluid phase and outputting a second fluid parameter signal representative of a second sensed second fluid parameter; and
wherein the determining whether the cut point is to be adjusted includes determining from the received second fluid parameter signal in conjunction with the received first fluid parameter signal whether the cut point is to be adjusted.

17. The method of claim 14, wherein fluid parameter comprises a density of at least one of the separated heavy fluid phase and the separated light fluid phase.

18. The method of claim 14, further comprising automatically controlling at least one centrifuge parameter on the fly.

19. The method of claim 18, wherein automatically controlling at least one centrifuge parameter on the fly includes automatically controlling a bowl speed, a differential speed, a feed rate, a temperature, or combinations thereof.

20. The method of claim 14, wherein the position of the radially adjustable paring disc is controlled from outside a bowl assembly of the decanting three-phase centrifuge.
